(19) United States
(12) Patent Application Publication
(10) Pub. No.: US 2019/0178482 A1
(43) Pub. Date: Jun. 13, 2019

(54) FLAT PANEL LIGHT FIXTURE MOUNTING KIT AND METHOD

(71) Applicant: Canarm Ltd., Brockville (CA)

(72) Inventor: James A. Cooper, Brockville (CA)

(21) Appl. No.: 16/176,505

(22) Filed: Oct. 31, 2018

Related U.S. Application Data
(60) Provisional application No. 62/597,718, filed on Dec. 12, 2017.

(51) Int. Cl. F21V 23/00; F21V 19/00

(52) U.S. Cl. CPC F21V 23/002; F21Y 2115/10; F21V 19/0015

(57) ABSTRACT

We disclose a kit and associated method for mounting a flat panel light fixture to a surface. The kit includes: a flat panel light fixture having opposing front panel and rear panels, a light-emitting element, fixture wires for electrically connecting the light-emitting element to household wires, and fixture-mounting openings extending through the fixture; a quick-connect unit for mounting to a junction box installed within the surface and for electrically connecting the fixture wires to the household wires; a tether for suspending the fixture from the junction box; and a plurality of attachment members configured to extend through the openings within the fixture and into the surface to secure the fixture to the surface in a first position wherein the fixture is spaced from the surface and a second position wherein the fixture is mounted in contact with the surface.

### FIELD

The invention relates to lighting fixtures, and in particular a kit and associated method for mounting a flat panel lighting fixture to a surface such as a ceiling or wall.

### BACKGROUND

The development of lightweight and highly efficient LED lights and in particular flat panel lighting fixtures has opened up new possibilities for illuminating spaces. Uses for such lighting fixtures include replacing existing ceiling lamps with relatively large and bright flat panel fixtures. Due to their light weight structure, even relatively large fixtures can be safely mounted directly to drywall or other ceiling or wall surfaces. Due to their thin profile, there is less need to recess such fixtures into the surface, in comparison with conventional fluorescent tube fixtures. As such, LED panel lighting fixtures can be flush-mounted to a ceiling or other surface.

A variety of flat panel LED lighting fixtures exist on the market, including edge-lit and rear-lit fixtures. A typical panel fixture includes a translucent or transparent front panel, optionally a solid rear panel which contacts the wall or ceiling and a rim or other structure which spaces the panels apart or otherwise spaces the front panel from the mounting surface and lighting elements. In an edge-lit configuration, LED lighting elements may be incorporated into the rim to evenly illuminate the front panel to provide a bright and even illumination across the full width of the panel.

It is desirable to provide a means to quickly and easily mount such fixtures to a surface, in particular this need arises since fixtures of this type are often purchased by home owners for replacing an existing lighting fixture, for example in order to upgrade the household lighting to improve efficiency and illumination. As well, rapid and easy installation systems are useful for professional installers such as home builders and electricians.

Different systems have been proposed to mount a lightweight panel-type light fixture to a surface. For example, U.S. patent publication No. 2017/0009962 to Feit describes an LED flat panel device which mounts to an electrical junction box via a mounting bracket. A similar system is described in 2015/0338038 to Feit. However, there remains a need for improved mounting systems for flat panel and other lighting fixtures.

### SUMMARY

The invention relates to an improved system for mounting a lighting fixture such as a flat panel lighting fixture to a surface such as a ceiling. The improved system includes a kit and related method for installing a flat panel fixture to a surface.

We disclose herein a kit for mounting a flat panel light fixture to a surface, the kit comprising:
a flat panel lighting fixture comprising a front panel which transmits light, a rear portion for contacting the surface, a light-emitting element, fixture wires for electrically connecting the light-emitting element to household wires, and fixture-mount openings extending through the fixture;
a quick-connect unit for electrically connecting the fixture wires to the household wires and configured for mounting to a junction box installed within the surface;
a tether for suspending the fixture from the junction box; and
a plurality of attachment members configured to extend through the openings within the fixture and into the surface to secure the fixture to the surface. In one embodiment, the attachment members are configured to retain the fixture in a first position wherein the fixture is spaced from the surface and a second position wherein the fixture is mounted in contact with the surface.

We further disclose a method of mounting a flat panel light fixture to a surface, comprising the steps of:
exposing an electrical junction box within the surface, the junction box housing household wires;
attaching an electric wire quick-connect unit to the junction box; attaching the household wires to a quick-connect unit;
tethering the fixture to the junction box;
attaching fixture wires from the light fixture to the quick connect unit to electrically connect the fixture wires to the household wires; and
attaching the fixture to the surface with a plurality of attachment members, wherein the attachment members are configured to extend through openings within the fixture and into the surface to secure the fixture to the surface. In one embodiment, the attachments members secure the fixture in a first position wherein the fixture is spaced from the surface and a second position wherein the fixture is mounted in contact with the surface.

Unless otherwise stated, directional references in the present specification refer to the present device in a generally horizontal orientation consistent with the lighting fixture mounted to a horizontal ceiling. It will of course be evident that the device may be used in any orientation. Furthermore, geometric and directional terms such as “horizontal”, “vertical” and the like are understood to include a reasonable degree of departure from the absolute meaning of such terms, as would be understood by persons skilled in the art. Furthermore, various dimensions, specifications and similar parameters are provided herein simply by way of example and are not intended to limit the scope of the invention, unless otherwise stated.

### BRIEF DESCRIPTION OF THE DRAWINGS

The present invention will now be further illustrated by reference to drawings and a description of a selected embodiment. However, it will be understood that the following drawings and description are not intended to limit the scope of the invention, which is provided in the present specification as a whole, including the claims.

FIG. 1 is a perspective view of an electrical quick-connect unit, installed to an electrical junction box.

FIG. 2 is a perspective view showing a lighting fixture in the process of installation to a surface.

FIG. 3 is a further perspective view of the mounting and assembly process.

FIG. 4 is a perspective view, showing the lighting fixture attached to the surface.

FIG. 5 is a cross-sectional view showing a lighting fixture in a partially-installed position.

FIG. 6 is a cross-sectional view showing a lighting fixture in a fully-installed position mounted to a ceiling.

### DETAILED DESCRIPTION

Referring to the figures, according to the method and system described herein, a panel-type lighting fixture 10 is mounted to a surface 12 such as a ceiling (see FIGS. 4-6). Surface 12 may comprise conventional drywall or other building material, and may be a flat surface or instead consist of an array of beams or other three dimensional or relieved structure. Surface 12 is not limited to a ceiling, but may consist of a wall, sloping surface or any other surface to which a lighting fixture may be installed. Furthermore, it is contemplated that in most installations, electrical wiring will have been installed beneath or behind the surface, for example household wiring in the joist or inter-beam spaces within a ceiling structure. However, the invention may be adapted for use with other wiring arrangements such as electrical wiring housed within external conduits and the like. A typical installation is performed in a residential or commercial setting but is not limited to these. In the present description, the terms “residence”, “house”, “household” and similar terms are used broadly to refer to any location where a lighting fixture may be installed, either indoors or outdoors, and is not limited to any particular type of setting.

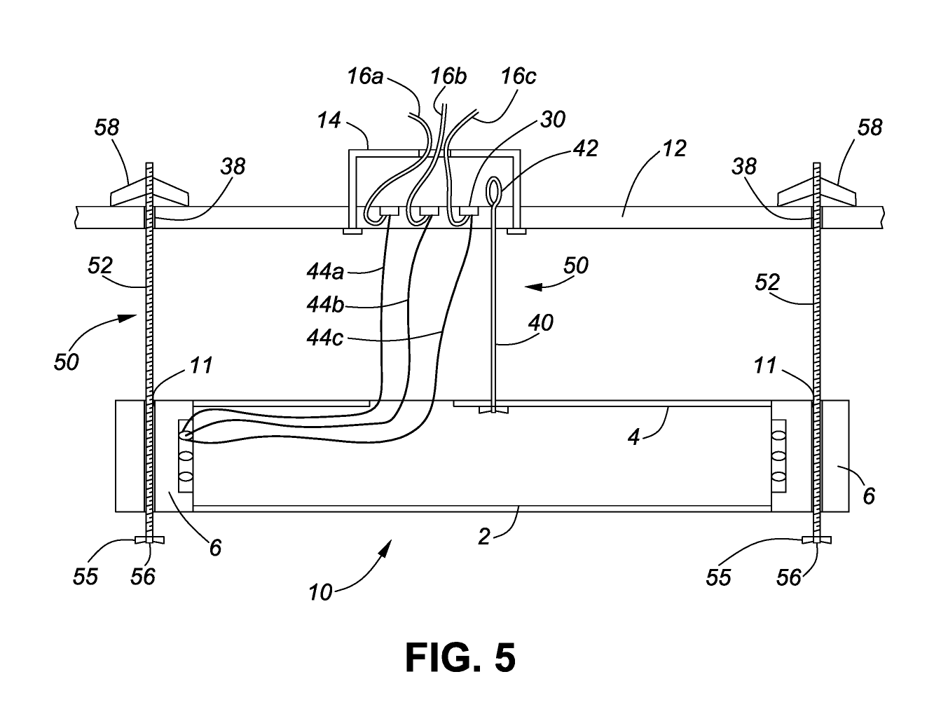

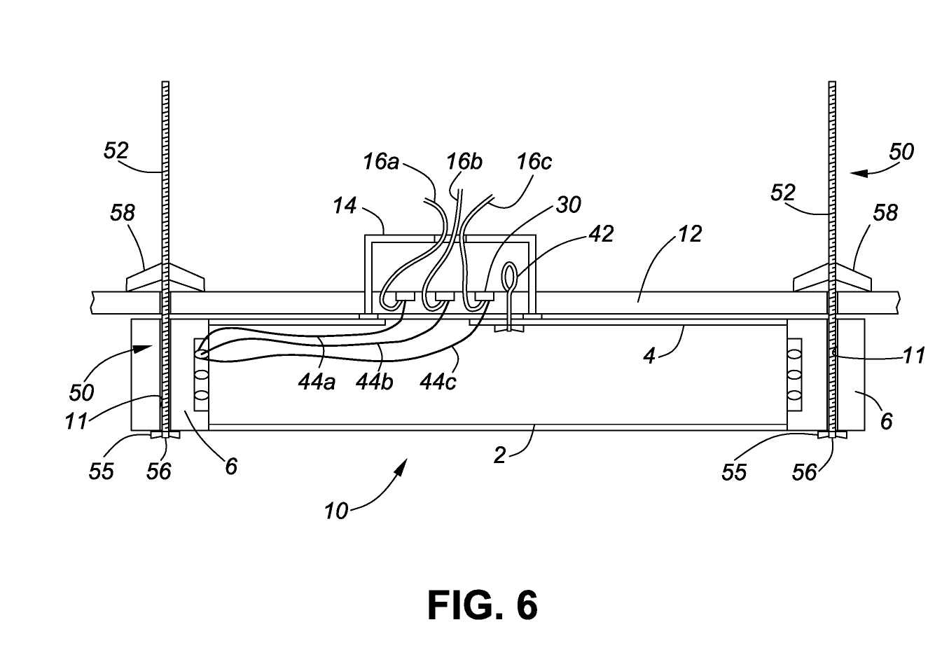

As an initial step, an electrical junction box 14 is installed within surface 12 (see FIGS. 5 and 6). Junction box 14 may comprise a conventional electrical junction box composed of metal walls, which is configured to retain household electrical wires 16 and isolate these from the surrounding environment. Junction box 14 comprises a sidewall 18, a floor 20 having an opening 21 for household wires 16 and mounting means such as threaded or unthreaded openings (not shown) such as screw or bolt holes to secure the junction box to beams or other support structures. Junction box 14 further comprises threaded openings (not shown) which are normally used to attach an electrical fixture to the junction box. Junction box 14 is exposed for access, to permit installation of fixture 10 according to the present method. For example, if junction box 14 is installed within a drywall-covered ceiling, an opening within the drywall is provided to expose junction box 14. Installation of junction box 14 may occur either as a first step in the installation process, or alternatively, lighting fixture 10 may be installed using a previously-installed junction box 14, for example if fixture 10 is being installed as part of a renovation of an existing structure.

For safety, the electric current is turned off before the installation begins. If fixture 10 is being installed as a replacement for an existing lighting fixture, the old fixture is removed to expose junction box 14.

The lighting fixture 10 according to the present system comprises a lightweight LED panel illumination system, having a front panel 2 which is translucent or transparent to transmit illumination (for example, a translucent plastic material), an opposing rear panel 4 which is solid for securing to a surface and a peripheral rim 6 which spaces the respective front and rear panels 2 and 4 apart and extends around the periphery of the spaced apart panels. Fixture 10 is generally planar in configuration, defined by a central flat plane parallel to front and rear panels 2 and 4 and bisecting rim 6. However, the panel illumination system may comprise a non-planar configuration, or whereby front and rear panels 2 and 4 are non-parallel. Lighting elements (not shown) illuminate the space between the panels. For example, fixture 10 may comprise an edge-lit LED lighting panel in which the lighting elements comprise LED emitters mounted within the rim of the panel. However, the invention is not limited to such fixtures and may be adapted for use with a wide range of panel-type and other lighting fixtures.

FIG. 10 has openings 11 configured as unthreaded bolt-holes that extend through the fixture to permit mounting of fixture 10 to surface 12. Openings 11 may be provided in any suitable locations of fixture 11 but typically are provided within rim 6 to avoid penetrating front panel 2, and oriented to pass through the central plane of fixture 10 in a direction transverse to the plane. Openings 11 penetrate rim 6 from the front to the rear surfaces thereof to permit an attachment member 50 (described below) to extend through rim 6 in an orientation which is transverse to the place of fixture 10. Four such openings 11 may be provided adjacent to corners of fixture 10. The diameter of openings 11 permit attachment members 50 to slide through openings 11 for mounting fixture 10 to surface 12.

The initial step for installation of fixture 10 is to install junction box 14 within a ceiling, wall or other surface. Junction box 14 may be newly installed if the installation occurs in the course of new construction or renovation. Alternatively, one can expose a pre-installed junction box 14, for example by removing an existing light fixture (not shown) from the surface. Conventional household wires 16 that extend into the junction box 14 normally consist of black, white, and green (or other colour) wires 16a, 16b and 16c, representing positive, negative and ground. Wire cores are exposed at the ends of wires 16 to permit electrical connections to be formed, for example by stripping a portion of the outer covering from the wires.

An electrical quick connect unit 30 is then attached to junction box 14. The quick connect unit 30 comprises a plate 32 having slotted mounting openings 31 at the opposing ends thereof. Plate 32 has a generally elongate rectangular configuration, with a flat central portion 35 and downwardly stepped (when quick connect unit 30 is horizontal and oriented for installation into a ceiling) end portions 37 which include the mounting openings 31. Plate 32 is screwed or bolted onto junction box 14 through openings 31, which in turn are aligned with corresponding openings provided in junction box 14 that are normally used for attaching a light fixture. When thus installed, flat middle portion 35 projects upwardly into the interior of junction box 14 such that the components of unit 30 and the various wires connected thereto are recessed within the interior of junction box 14.

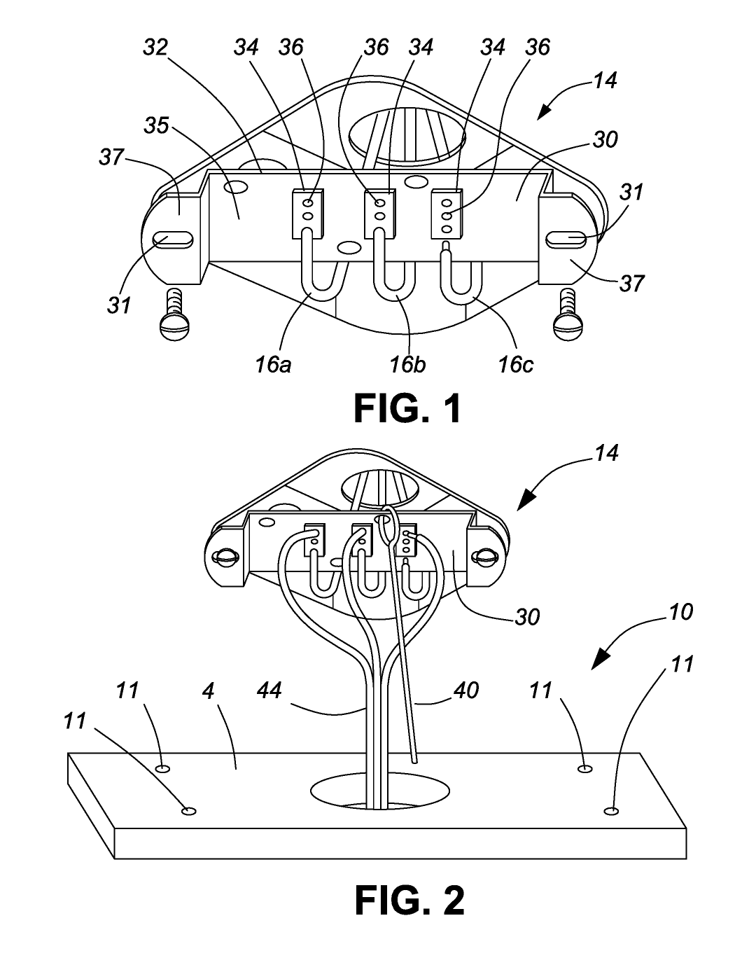

Quick connect unit 30 comprises three quick connects modules 34 (for connection to the three household wires in a conventional household electrical wiring configuration) mounted to the middle portion 35 of plate 32, each in turn comprising a rectangular block-like member. Modules 34 may be of the type described in applicant's patent number U.S. Pat. No. 9,065,264 to Cooper et al. Quick connect modules 34 each have multiple sockets 36 that open to the exposed face (i.e. facing fixture 10) of quick connect modules 34. The sockets 36 are in turn lined with an electrically conductive material such as copper, with the sockets 36 being electrically connected to each other within the interior of each member 34, for example with a conductive plate, not shown. Sockets 36 are configured to tightly retain and grip an electrical wire when this is inserted into the socket. As shown in FIG. 1, household wires 16 a to c are inserted into corresponding sockets 36 within the three quick connect modules 34, whereby each of the three quick connect modules 34 is thus electrically connected to a separate one of the household wires 16.

The next installation step is illustrated in FIG. 2. In this step, light fixture 10 is temporarily suspended from the junction box 14 via a tether 40 that is fixed to the rear panel of fixture 10. Tether 40 comprises a flexible cable or cord, a first end of which is securely anchored to the rear panel. Fixture 10 may be supplied with tether 40 already attached, or alternatively tether 40 may be attached on-site to panel 10 by the installer, for example via a screw-threaded attachment (not shown) or other conventional attachment means. The opposing (free) second end of tether 40 comprises an attachment member or attachment means such as clip, hook or other conventional means for attaching the second end of the cable to the junction box 14 or plate 32 of quick connect unit 30. In the present example, the attachment means comprises an openable loop 42 such as a carabineer, which may be secured through a hole within the quick-connect plate. The tether temporarily suspends the fixture from the junction box, which frees up the installer's hands to allow the fixture wires to be electrically connected. Tether 40 has sufficient tensile strength to easily support fixture 10 and as well to accommodate additional tugging or weight-bearing that the installer may place on fixture 10 during installation. The length of tether 10 is sufficient to allow the installer to easily manipulate fixture 10 during installation, for example in the range of 6 to 24 inches.

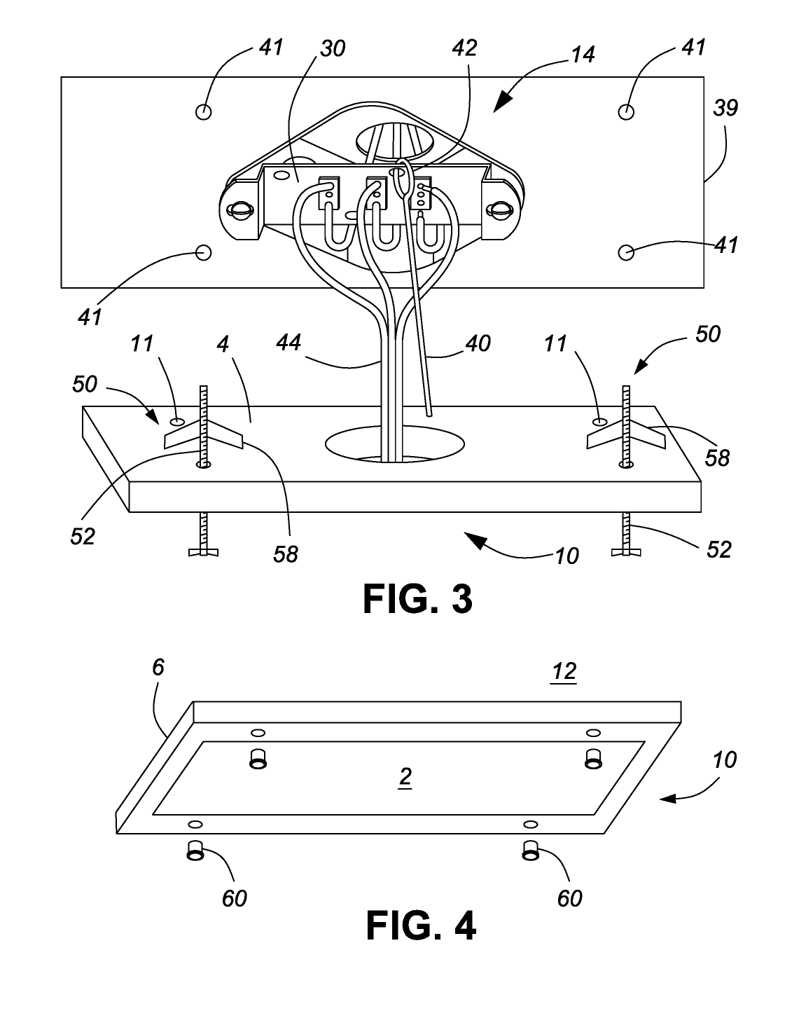

As shown in FIG. 3, the subsequent step for mounting fixture panel 10 is to drill holes 38 into surface 12 at preset locations aligned with openings 11 in fixture 10. For this purpose, a template plate 39 is provided, having holes 41 located in specific locations which correspond to openings 11 within fixture 10. Template 39 may also have a central opening 43 which corresponds to a conventional junction box to allow the template to easily be aligned with and centered over the junction box. Typically, template 39 comprises a cardboard sheet, having holes 41 or markings in the specific locations for the selected fixture 10. Template 39 may be temporarily attached to surface 12 in a desired orientation aligned with the desired position of fixture 10. Template 39 may be held in position on surface 12 using tape or alternatively it may simply be held against surface 10 in a desired position. The installer then marks surface 12 with the specific drill locations or simply drills holes into the surface through template 39 at the pre-marked locations provided in template 39.

The next installation step is to electrically connect the temporarily suspended panel 10 to the household wires 16. For this purpose, as seen in FIGS. 2 and 3, lighting fixture 10 includes three electrical wires 44a, b and c extending through an opening in the rear panel (positive, negative and ground). Within the interior of fixture 10, wires 44 are electrically connected to the LED emitters of fixture 10 in a conventional manner, not shown. The free ends of the respective fixture wires 44 have exposed cores, which are inserted into respective sockets 36 of the quick connect modules 34. Conventionally, the fixture wires 44 are colour coded in a similar fashion as conventional household wiring (for example, black, white and green). The respective fixture wires 44 are inserted into sockets 36 of the quick connect modules 34 that correspond with the corresponding household wires. In this fashion, electrical connections are formed between the respective fixture wires 44 and respective ones of the household wires 16. Once the electrical connections have been suitably formed, fixture 10 may then be mounted in its final installation position so as to contact the ceiling or other surface 12.

Lighting fixture 10 is then secured to surface 12 with attachment members 50. In FIG. 3, two such members 50 are shown for clarity. However, in most cases four attachment members 50 would be provided, adjacent to the four corners of fixture 10. The attachment members 50 comprise externally threaded rods 52 that are inserted through holes 11 within fixture 10 that are adjacent to the four corners of the panel member. A first end of rod 52 has an enlarged head 55 which has a slot 56 or other socket to receive a screw driver or other tool for rotating rod 52. Collapsible anchors 58, such as spring-loaded drywall butterfly anchors, are threaded onto the free end of the rods 52. Rods 52 are then inserted into the holes 38 within the surface, such that the anchors are compressed into a folded configuration in which they can be inserted through holes 11.

When rods 52 are partially inserted whereby the anchors 58 are located within the wall or a ceiling cavity behind surface 12, anchors 58 then release their spring-loaded wings into an expanded position that engages the backside of the drywall or other wall surface 12, to thereby anchor attachment rods 52 to surface 12. In this position, fixture 10 is spaced from surface 12. If required, when fixture 10 is in this spaced position, the wire connections may be checked and/or other components may be inspected before the installation process is completed. After all four anchors 58 have been inserted in this fashion and engaged with surface 12, rods 52 are then threaded further into anchors 58 until fixture 10 is snugly engaged to the surface 12. At this point, rod heads 55 are recessed within openings 11 in the panel 10. The fixture openings 54 may then be covered with decorative plugs 60 to present a flush appearance. As the fixture panel 10 is tightened against surface 12, tether 40 will tend to fold together and collapse into junction box 14 or through any other available space such as an opening in fixture 10. Alternatively, tether 40 can be removable, whereby it is removed once attachment rods 52 engage surface 12, but while fixture 10 is still spaced apart from the surface 12 to permit manipulation of tether 40. The resulting installation provides a means to mount fixture 10 to surface 12 in a manner that is secure and convenient for the installer.

The scope of the invention should not be limited by the preferred embodiments set forth in the examples but should be given the broadest interpretation consistent with the description as a whole. The claims are not to be limited to the preferred or exemplified embodiments of the invention.

1. A kit for mounting a flat panel light fixture to a surface, the kit comprising:
a flat panel light fixture comprising a front panel which transmits light, a rear portion for contacting the surface, a light-emitting element, fixture wires for electrically connecting the light-emitting element to household wires, and fixture-mounting openings extending through the fixture;
at least one quick-connect unit for electrically connecting the fixture wires to the household wires and configured for mounting to a junction box installed within the surface;
at least one tether for suspending the fixture from the junction box; and
a plurality of attachment members configured to extend through the openings within the fixture and into the surface to secure the fixture to the surface.

2. The kit of claim 1 wherein the light fixture comprises an edge-lit LED light fixture.

3. The kit of claim 1 wherein the at least one quick connect unit comprises a plurality of quick connect modules each comprising a first socket for engaging a selected one of the household wires, a second socket for engaging a corresponding fixture wire, and internal electrical connectors for transmitting electrical current between the first and second sockets.

4. The kit of claim 1 wherein the at least one tether comprises a cable attached to the fixture at one end thereof and an attachment member at an opposing end thereof for anchoring the cable to the junction box.

5. The kit of claim 1 further comprising a removable template for marking locations on the surface for drilling holes corresponding to the locations of the attachment members.

6. The kit of claim 1 wherein the attachment members each comprise an anchor for engaging the surface and a shaft configured to engage the fixture at a first end of the shaft and to engage the anchor at an opposing second end of the shaft, wherein the anchor and shaft are configured for mutual engagement whereby the shaft is drawn through the anchor between the first and second positions.

7. The kit of claim 6 wherein the anchor is a drywall anchor.

8. The kit of claim 6 wherein the shaft comprises threaded rod and the anchor includes a threaded opening whereby the rod is threaded through the threaded opening to mount the fixture to the surface in the second position.

9. The kit of claim 1 wherein the tether comprises flexible member that is configured to collapse when the fixture is installed.

10. The kit of claim 1 wherein the attachment members are configured to retain the fixture in a first position wherein the fixture is spaced from the surface and a second position wherein the fixture is mounted in contact with the surface.

11. The kit of claim 10 wherein the attachment members protrude from the front panel when in the second position whereby an installer can manipulate the attachment members.

12. A method of mounting a flat panel light fixture to a surface, comprising the steps of:
exposing an electrical junction box within the surface, the junction box housing household wires;
attaching at least one electrical wire quick-connect unit to the junction box;
attaching the household wires to the at least one electrical wire quick-connect unit;
tethering the fixture to the junction box;
attaching fixture wires from the light fixture to the at least one quick connect unit to electrically connect the fixture wires to the household wires; and
attaching the fixture to the surface with a plurality of attachment members, wherein the attachment members are configured to extend through openings within the fixture and into the surface to secure the fixture to the surface.

13. The method of claim 12 wherein the fixture is brought into contact with the surface in the second position by engaging the attachments members with anchors, wherein the anchors are engaged to the surface.

14. The method of claim 12 comprising use of the kit of claim 1.

15. The method of claim 14 wherein the light fixture comprises an edge-lit LED light fixture.

16. The method of claim 14 wherein the at least one quick connect unit comprises a plurality of quick connect modules each comprising a first socket for engaging a selected one of the household wires, a second socket for engaging a corresponding fixture wire, and internal electrical connectors for transmitting electrical current between the first and second sockets.

17. The method of claim 14 wherein the at least one tether comprises a cable attached to the fixture at one end thereof and an attachment member at an opposing end thereof for anchoring the cable to the junction box.

18. The method of claim 12 further comprising use of a removable template for marking locations on the surface for drilling holes corresponding to the locations of the attachment members.

19. The method of claim 12 wherein the attachment members each comprise an anchor for engaging the surface and a shaft configured to engage the fixture at a first end of the shaft and to engage the anchor at an opposing second end of the shaft, wherein the anchor and shaft are configured for mutual engagement whereby the shaft is drawn through the anchor between the first and second positions.

20. The method of claim 12 wherein the tether comprises a flexible member that is configured to collapse when the fixture is installed.

21. The method of claim 12 wherein the attachment members are configured to retain the fixture in a first position wherein the fixture is spaced from the surface and a second position wherein the fixture is mounted in contact with the surface.

22. The method of claim 21 wherein the attachment members protrude from the front panel when in the second position whereby an installer can manipulate the attachment members.
